(19) United States
(12) Patent Application Publication
(10) Pub. No.: US 2016/0168886 A1
(43) Pub. Date: Jun. 16, 2016

(54) Screwless Mounted Short-Throw Lock for Sliding Windows and Doors

(71) Applicant: Vision Industries Group, Inc., So. Plainfield, NJ (US)

(72) Inventors: Luke Liang, So. Plainfield, NJ (US); Tong Liang, Guangzhou (CN); David Chen, Guangzhou (CN)

(73) Assignee: Vision Industries Group, Inc., So. Plainfield, NJ (US)

(21) Appl. No.: 14/965,273

(22) Filed: Dec. 10, 2015

Related U.S. Application Data
(60) Provisional application No. 62/090,454, filed on Dec. 11, 2014.

(51) Int. Cl. E05C 1/10; E05C 19/06

(52) U.S. Cl. CPC E05C 1/10; E05C 19/06

(57) ABSTRACT

A screwless-mounted window/door lock may include a handle assembly and tongue assembly. The handle assembly may include a base member, a handle member pivotally mounted thereto, and an elongated arm disposed through an opening in the base member, with a central portion pivotally mounted thereto. The handle drives the arm to pivot. The base member has a plurality of selectively arranged hook members, a portion of which are received through an opening in a side wall of the window/door frame to secure the handle assembly thereto in the horizontal direction. The tongue assembly may include a tongue slidably received in a housing. The tongue is actuated by pivotal movement of the arm. A second portion of the book members on the base member are received through a top wall of the frame to engage protrusions on the tongue housing to secure the handle assembly thereto in the vertical direction.

### CROSS REFERENCES TO RELATED APPLICATIONS

This application claims priority on U.S. Provisional Application Ser. No. 62/090,454 filed on Dec. 11, 2014, the disclosures of which are incorporated herein by reference.

### FIELD OF THE INVENTION

The present invention relates to improvements in locks for sliding windows and doors, and more particularly to a lock which requires no screws for its installation upon the fenestration product, and which also requires a relatively short throw to either lock or to unlock the window/door.

### BACKGROUND OF THE INVENTION

There are many different locks that are available for use in securing a window or door in its closed position with respect to the master window frame (or master door fame) within which it normally slides. Most of these locks are particularly adapted so that they may receive a plurality of screws through its housing in order to properly mount the lock to the frame of the window (or door). The lock of the present invention is instead configured so that it may mount to the window frame or the door frame without the use of any screws, thereby eliminating the extra parts, and also the labor required to install them. In addition, the lock of the present invention is also particularly adapted so that its handle may be moved only a small amount in order to actuate the lock between the locked and unlocked positions.

### OBJECTS OF THE INVENTION

It is an object of the invention to provide an improved lock tor sliding windows and doors that does not require screws for its installation thereto.

It is another object of the invention to provide an improved lock tor sliding windows and doors which requires a throw of less than 10 degrees to actuate the lock between the locked and the unlocked positions.

Further objects and advantages of the invention will become apparent from the following description and claims, and from the accompanying drawings.

### SUMMARY OF THE INVENTION

A lock, for use on sliding doors and on sliding windows, maybe configured for screwless mounting to the window/door frame. The screwless-mounted lock may broadly include a lock handle assembly and a tongue assembly.

The lock handle assembly may broadly include a base member, a handle, and a pivotal arm.

The base member may be formed to have a first flange with a through-opening, and a first hook member and a second hook member each protruding from one side of the flange, with the first and second hook members being oriented to face each other. The base member may also broadly include a second flange extending away from the first flange, having at least one hook member protruding therefrom, and may more desirably may have two hook members protruding therefrom. Each of the hook members on the second flange may face in the same direction, and each may extend away from the second flange towards the first and second hook members of the first flange (i.e., they may be at a right angle to the first and second hook members on the firth flange).

The handle member maybe pivotally coupled to the first flange, to be pivotable between at least a first position and a second position. The handle member may broadly include at least one protrusion.

The pivotal arm may be elongated, having a first end and a second end. A portion of the elongated arm including its first end may be received through the opening in the first flange of the base member, and may be pivotally mounted to the first flange, such that a portion of the protrusion on the handle may selectively engage and drive the second end of the arm. When the handle is pivoted from the first handle position to the second handle position, that portion of the handle protrusion may drive the second end of the arm to pivot and correspondingly move the first end of the arm from a first arm position to a second arm position.

The tongue assembly may broadly include a tongue and a tongue housing.

The tongue housing may have a first opening into a cavity therein, and a transverse opening into the cavity. The tongue housing may broadly include a face plate feature, a flexible tab feature with a protruding lip positioned at a discrete lateral distance away from the face plate, and first and second side protrusions.

The tongue may be configured to be slidably received through the first opening in the tongue housing, to be slidable between a stowed position where the tongue is retracted within the cavity an at least one extended position. The tongue may broadly include an opening with at least a portion thereof configured to be aligned with the transverse opening in the tongue housing.

The lock handle assembly may be secured to the frame of the window/door, in part, by forming three suitably sized and positioned openings in the top wall of the frame, and at least one suitably sized and positioned opening in a first side wall of the frame, which may be the side wall opposite from the master window frame. Two of the three openings in the top wall of the frame may be configured for the first and second hook members on the one side of the flange of the base member to pass therethrough. The hook members may pass through the openings without engaging the frame. The third opening, which may be positioned between the other two openings on the top wall of the frame, may be configured for a portion of the pivotal arm to pass therethrough, which may include its first end. The at least one opening in the first side wall of the frame may be configured to receive the at least one hook member protruding from the second flange of the base member, which may secure the lock handle assembly with respect to the window/door frame in the lateral direction.

The tongue assembly may be installed in the frame of the window/door, in part, by forming a suitably sized and positioned opening in a second side wall of the frame, which may be the side wall that is adjacent to the master window frame. The tongue housing may be slid into the opening in the second side wall. The positioning of the opening on the second side wall of the frame and the positioning of the first and second side protrusions on the tongue housing may be such that during sliding of the tongue housing into the opening in the second side wall, those first and second tongue protrusions are respectively engaged within the first and second hook members of the first flange of the base member, to then also secure the base member with respect to the frame, in the vertical direction. The tongue housing may be secured with respect to sliding outwardly from the frame using the face plate feature and the protruding lip of the flexible tab feature. As the tongue housing is being slid into the opening in the second side wall, the tab may deflect inward into the tongue housing as the protruding lip contacts the edge of the opening in the second side wail. The tongue housing may be slid into the opening in the second side wall until the face plate contacts the frame side wall, at which time the protruding lip of the flexible tab will be clear of the housing wall, and the flexible tab may return to its un-deflected position, nesting the thickness of the frame side wall between the face plate and tab lip, while leaving the tongue free to egress from the tongue housing.

Being so installed, the first end of the arm may protrude through the transverse opening in the tongue housing to be movably engaged within the aligned opening in the tongue, wherein the movement of the first end of the arm between the first and second arm positions, as a result of the handle being moved between its first and second positions, may selectively cause corresponding movement of the tongue between the retracted position and an extended position.

The distance that the first end of the arm is positioned away from its pivotal axis maybe greater than the distance that the second end of the arm is positioned away from the pivotal axis, which may provide for a short “throw” in order for the handle to actuate the tongue, for locking and unlocking of the lock.

The portion of the handle protrusion that is configured to selectively engage and drive the first end of the aim may advantageously take at least two different forms.

First, that portion of the handle member protrusion may be formed into a pin that may be cylindrical, and a portion of the arm proximate to its second end may be formed to have a selectively shaped cam surface, wherein the pin may engage the cam surface to drive the arm. The cam surface may be formed in the top of an opening in the arm.

Second, that portion of the handle member protrusion may be formed into a laterally protruding flange, and the second end of the arm may be formed to have a rounded surface, wherein the laterally protruding flange may contact the rounded surface of the arm to drive the second end of arm.

Furthermore, the lock may also be configured so that actuation of the handle to move the tongue from its retracted position, to the extended (locking) position, and back to the retracted position, may be require two separate cycles of handle actuation.

A first such cycle may require lifting of the handle the short throw amount, to pivot the handle from its first handle position to the second handle position, and then subsequent releasing of the handle, to permit it to be biased into the intermediate handle position.

The second such cycle may again require lifting of the handle to move it back to the second handle position, and then subsequent releasing of the handle, to permit it to be biased into the first handle position.

For the lock to be configured for such cycling, the tongue assembly may broadly include further elements and features. Basing may be accomplished by a helical compression spring being positioned within the cavity of the tongue housing, so as to normally bias the tongue outward from the cavity, which biasing may be transmitted through the arm to the handle, to also bias the handle into the first handle position. Also, a shaped track may be formed on the tongue housing within the cavity, and an elongated flexible member may have a first end secured to the tongue, and a second end configured to selectively engage the shaped track on the tongue housing, in accordance with movements of the tongue.

This interaction between the elongated flexible member (which may be formed as a torsion spring) and the track may operate similar to the spring and track disclosed in the Applicant's co-pending application Ser. No. 14/090,124. However, such interaction is also briefly described hereinafter.

The track may he formed to include a central recess, and contouring on each side of the recess. The contouring may be configured to deflect the second end of the elongated flexible member in one of two lateral directions, in accordance with tongue movement from its extended position to the retracted position, or from its retracted position to its extended position.

In the first cycle, when the handle is actuated to overcome the biasing of the compression spring to pivot from the first handle position to the second handle position, the tongue may be caused to translate inward into a folly retracted position, and the selective engagement between the elongated flexible member and the track may correspondingly include: the second end of the flexible member initially moving in a first direction and subsequently being deflected in a first lateral direction from contact with a first contour of the track in conjunction with the tongue translating to its fully retracted position. After the handle is released, biasing by the compression spring may cause the tongue to move only slightly back towards it extended position, such that the second end of the flexible member may move in a second direction to engage a recess in the tongue housing track, to retain the tongue in an intermediate retracted position that is still disengaged from the master window frame which may also still be folly retracted within the tongue housing). With the tongue being held in this intermediate retracted position by the second end of the flexible member being engaged in the recess in the tongue housing track, the handle may be correspondingly maintained at an intermediate handle position being a position between the first handle position and the second handle position.

In the second cycle, when the handle is again actuated to overcome the biasing of the compression spring to pivot from the intermediate handle position to the second handle position, the tongue may be caused to translate inward slightly from the intermediate retracted position to its folly retracted position, and this movement of the tongue may correspondingly cause the second end of the flexible member to again move in the first direction to disengage from the recess. After the handle is released, biasing by the compression spring may cause the tongue to move back to its extended position. This movement of the tongue may correspondingly cause the second end of the flexible member to move in the second direction where it may contact a second contour of the track and initially be deflected in a second lateral direction, being directed away from the recess, but may finally reach the same position it occupied at the start of the first cycle. This tongue biased motion may also cause the handle to be biased from the second handle position to the first handle position.

### BRIEF DESCRIPTION OF THE DRAWINGS

FIG. 1 is a perspective view of the lock of the present invention, after being installed upon the frame of a window/door.

FIG. 2 is a reverse perspective view of the lock and window/door frame of FIG. 1.

FIG. 3 shows the reverse perspective view of the lock and window/door frame of FIG. 2, positioned adjacent to the master frame that is configured to receive the tongue of the lock to secure the sliding window/door.

FIG. 4A is a top perspective view of the lock handle assembly of the lock of FIG. 1, prior to being installed upon the window/door.

FIG. 4B is a bottom perspective view of the lock handle assembly of FIG. 4A.

FIG. 4C is an exploded view of the component parts of the lock handle assembly of FIG. 4A.

FIG. 5A is a top perspective view of the tongue assembly that may be installed into the window/door frame, in conjunction with the lock handle assembly of FIG. 4A, to form the lock of the present invention.

FIG. 5B is a bottom perspective view of the tongue assembly of FIG. 6A.

FIG. 6 is an exploded view of the component parts of the tongue assembly of FIG. 5A.

FIG. 7A is a front perspective view showing the cutouts formed in the top and first side of the frame of the window/door that are used for mounting of the lock handle assembly thereto.

FIG. 7B is a rear perspective view of the frame shown in FIG. 7A, showing a cutout in the second side of the frame for receiving the tongue assembly.

FIG. 8A is a perspective cutaway view of the lock handle assembly as its protruding hook members are initially being installed into the openings in the top of the frame of the window/door, but are not yet fully installed therein.

FIG. 8B is the perspective cutaway view of FIG. 8A, but shows the downward protruding hook members after being fully installed through the openings in the top of the frame, and also shows the tongue assembly initially being slid/installed into the slotted opening in the side of the frame of the-window/door.

FIG. 8C is the perspective cutaway view of FIG. 8B, but shown after the lock handle assembly has been slid further downward into the window/door frame, and slid sideways tor its side protruding hook members to pass through the opening in the side of the frame to become engaged therewith, and where the arm of the lock handle assembly has become engaged with the tongue of the tongue assembly, and with the tongue assembly slid further into the side of the frame for its side protrusions to be engaged by the downward protruding hook members of the lock housing assembly.

FIG. 8D is the perspective cutaway view of FIG. 8C, but is shown after the tongue assembly has been completely installed (slid) into the frame of the window/door, to be secured thereat by the frame wall becoming nested between the face plate of the tongue housing and an elongated tab with a lip that is formed on the bottom of the tongue housing.

FIG. 9A is a cutaway perspective view of the lock and frame of FIG. 1, showing the component parts of the locking device when in the locked position.

FIG. 9B is the cutaway perspective view of FIG. 3A, but showing the component parts of the lock when in the unlocked position.

FIG. 9C is a cutaway top view of the lock and frame of FIG. 1, showing the tongue biased into its extended position, and a second end of the second arm of the torsion spring of the tongue assembly being positioned distally from the contoured track that is formed in the tongue housing.

FIG. 9D is the cutaway top view of FIG. 9C, but showing the tongue after being translated into its fully retracted position, and the second end of the second arm of the torsion spring being positioned in a portion of the track, after being deflected laterally by a contour of the track (i.e., towards the bottom of the page) to avoid the recess therein.

FIG. 9E is the cutaway top view of FIG. 9D, but showing the second end of the torsion spring releasably engaged with the recess in the track, to releasably retain the tongue in a retracted position in which it is disengaged from the master window frame, and the lock is unlocked.

FIG. 10 shows a first embodiment of the openings that may be formed in the master frame of the door/window, in order to receive a keeper therein that may be engaged by the tongue, when the tongue is in the locked position.

FIG. 11A shows a front perspective view of a keeper that may be received within the openings of the master frame of FIG. 10.

FIG. 11B shows a rear perspective view of the keeper of FIG. 11A.

FIG. 12A shows the keeper of FIG. 11A installed within the openings of the master frame shown in FIG. 10.

FIG. 12B is a cutaway reverse perspective view of the keeper and master frame of FIG. 12A, showing the protrusion of the keeper received within a corresponding opening in the master fame, to secure the keeper therein.

### DETAILED DESCRIPTION OF THE INVENTION

As used throughout this specification, the word “may” is used in a permissive sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C”, “one or more of A, B, and C”, and “A, B, and/or C” means A alone, B alone, C alone, A and B together, A and C together, B and C together, or A, B and C together.

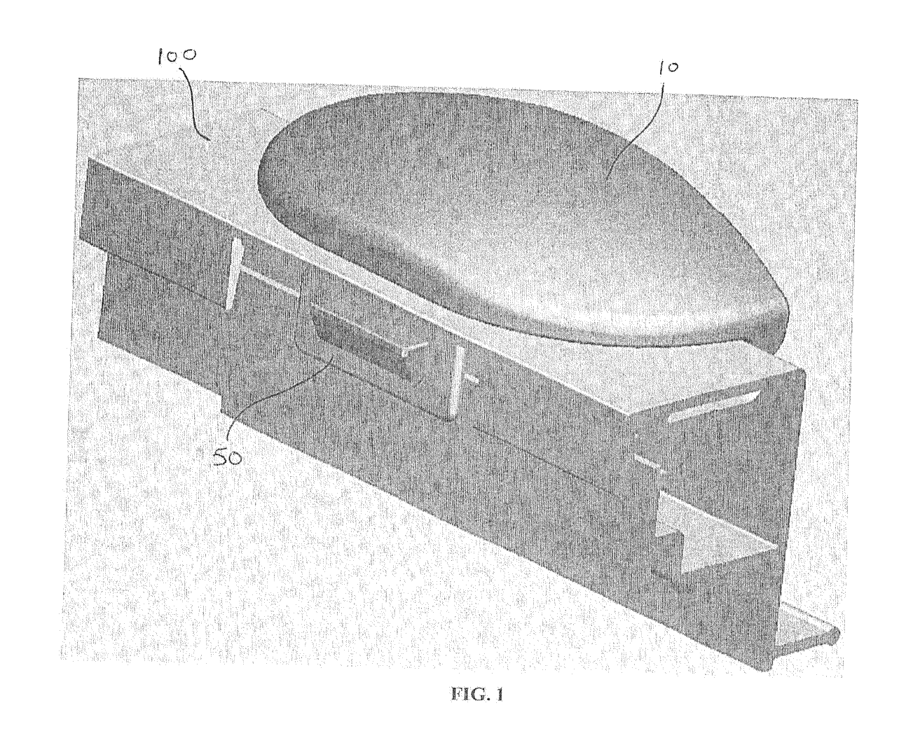

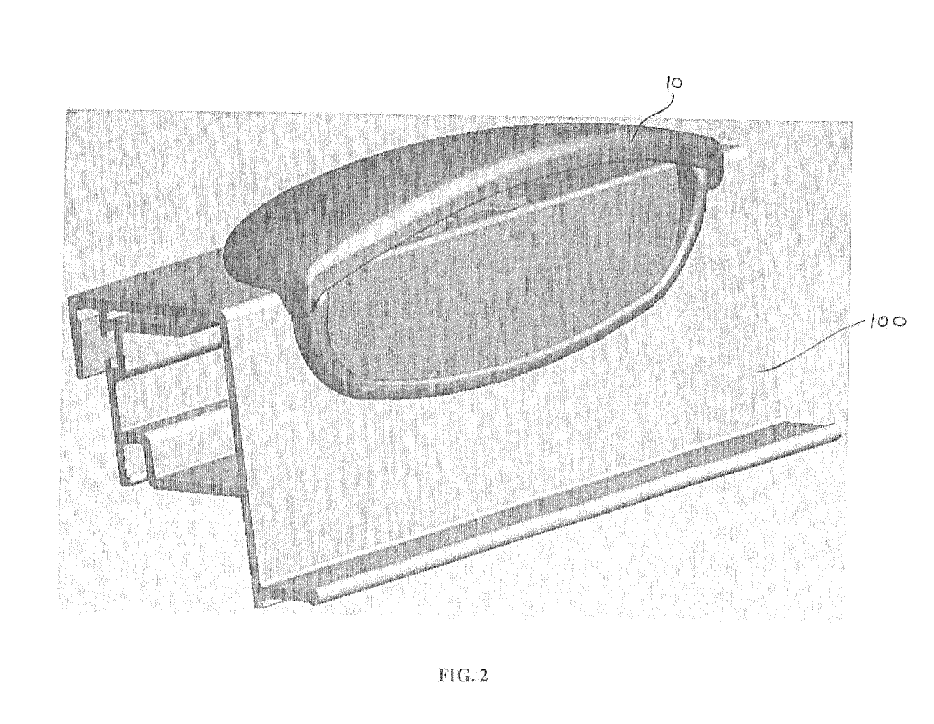

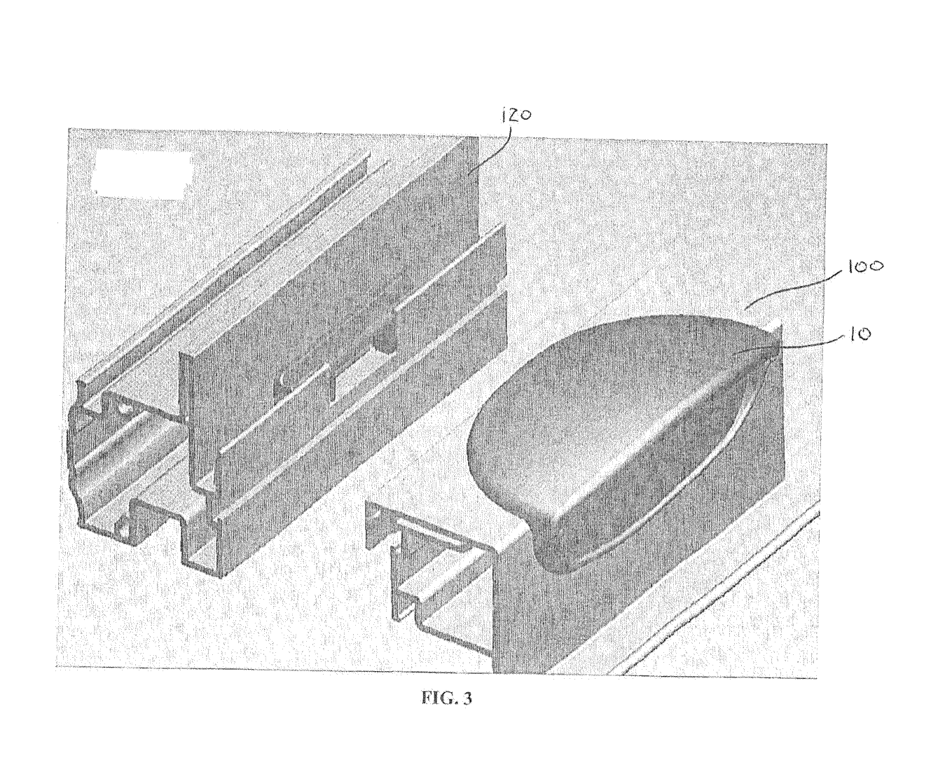

FIG. 1 is a perspective view of the lock handle assembly 10 and the tongue assembly 50 of the present invention, after being installed upon the frame 100 of a sliding door or window, FIG. 2 shows a reverse perspective view of the lock handle assembly 10 and the tongue assembly 50 pictured in FIG. 1, which is again shown in FIG. 3 adjacent to the master frame 120 that is configured to receive the tongue therein, for securing of the sliding window/door in the locked condition. The herein disclosed lock is not limited to use on only a single hung sliding sash window that is configured to slide in a master window frame. It may he used on any type of sliding window or sliding door (e.g., single hung, double hung, etc.). However, to simplify the following presentation, a description is provided in relation to installation of the herein disclosed lock upon a meeting rail of a sliding sash window, where the tongue of the lock assembly may engage and lock the sliding sash window with respect to the corresponding frame member of the master window frame. The lock may also be installed in any suitable orientation, and use herein of descriptive terms such as “up,” or “upper,” or “lower,” etc., are not meant to be limiting, and are only intended to be illustrative for the benefit of the reader.

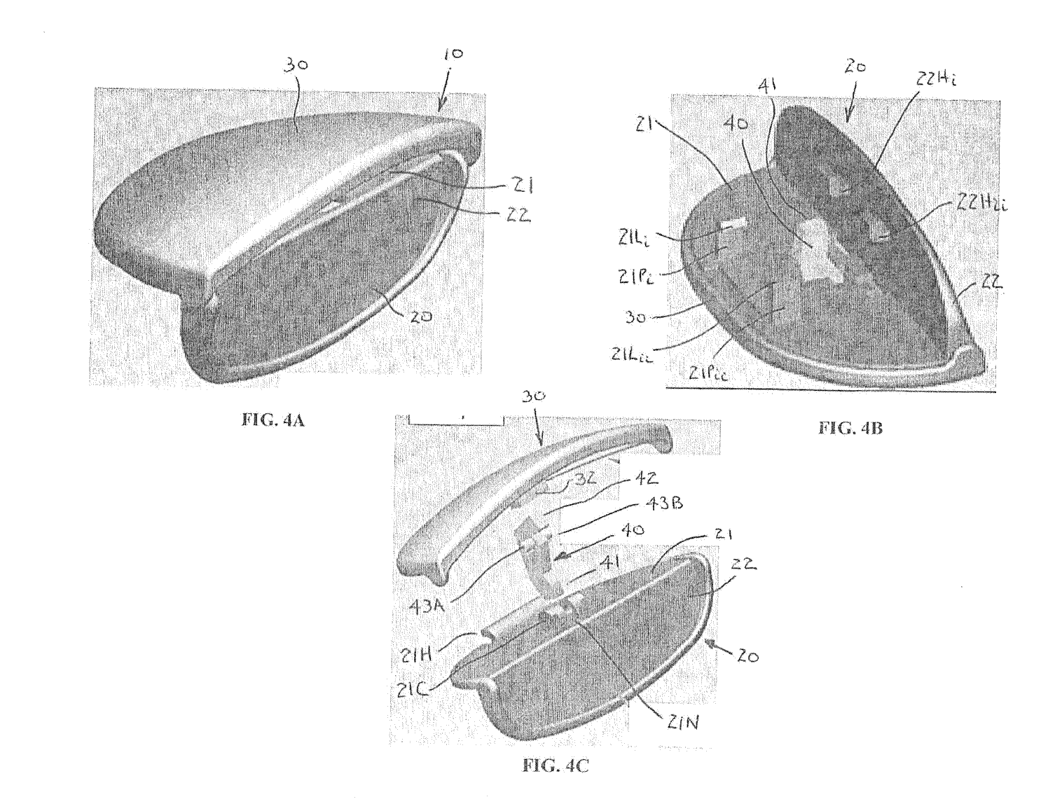

FIGS. 4A and 4B respectively show a front perspective view and a rear perspective view of the lock handle assembly 10, the component parts of which are shown in the exploded view of FIG. 4C. The lock handle assembly 10 may include abase member 20, a handle 30, and a driving arm 40.

As seen in FIG. 4C, the driving arm 40 may be formed to be an elongated member having a first end 41 and a second end 42. At a position between the first end 41 and the second end 42 of the driving arm 40 may be a cylindrical pin having a first portion 43A which may protrude outwardly from one side of the arm, and a second portion 43B, which may protrude outwardly from a second side of the arm. The pin may be a separate part fixedly secured to the driving arm, or it may instead be formed integrally therewith, and may thus be two separate pin members. Other pivotal mounting arrangements may also be used.

The base 20 may be formed into a generally L-shaped member, having a first flange 21, and a second flange 22 that may extend away from the first flange at an angle. Any angular relationship may also be used, however, for aesthetics and for a better fit upon a window/door frame (e.g., a meeting rail) that may have a top, generally horizontal wall, and an adjacent vertical wall, the angle between the first flange and the second flange may be approximately 90 degrees.

A first side of the first flange 21, the upper side as seen in FIG. 4C, may have a hook member 21H, which may be positioned proximate to its free end. The first flange 21 may have an opening 21N therein that is configured to permit the first end 41 of the driving arm 40 to freely pass therethrough. A clevis 21C may protrude upwardly from the first side of the first flange 21, and each of its first and second prongs may be positioned on opposite sides of the opening 21N. The prongs of clevis 21C may each have holes therein that may be adapted to respectively receive the cylindrical first pin portion 43A and second pin portion 43B of driving arm 40, to pivotally mount the driving arm to the base 20. The second end 42 of the driving arm 40 may extend away from the other side of the first flange 21. Thus, to create a short throw for the mechanical arrangement, the first end 41 of the arm 40 may be at a greater distance from the axis of its pivotal mounting, than the second end 42 is positioned from the pivotal axis. Since the axis for the pivotal mounting of the arm 40 may be very close to the mid-plane of the first flange 21, those respective distances to produce the short throw may also be considered in terms of the distance from each end of the arm to the corresponding side of the first flange 21.

Protruding from the other side of the first flange 21, the upper side as seen in the bottom perspective view of FIG. 4B, may be a first protrusion 21Pi and a second protrusion 2Pii, each of which may have a corresponding lip (21Li and 21Lii) formed thereon, to form a pair of hook members that may face each other. The lower side of each lip may be formed with a curved surface to permit it to deflect laterally upon being contacted in a vertical direction, as discussed hereinafter with respect to its installation into the openings of the frame 100 of the window/door.

The second flange 22 may be formed with one or more hook-shaped members thereon (e.g., 22Hi and 22Hii), which may also be used for installing of the lock handle assembly 10 upon the frame 100 of the window/door (e.g., the vertical wall of a meeting rail). The use of only the hook-shaped member 22Hi may be adequate to accomplish the installation as described hereinafter, however, the second hook-shaped member 22Hii may also be used to provide additional stability for the installation. Also note that such hook members may be formed so as to protrude directory from the first flange 21, without the need for the second flange 22, but which may be used to provide greater stability, and may also provide more suitable aesthetics for the interior of a window or door.

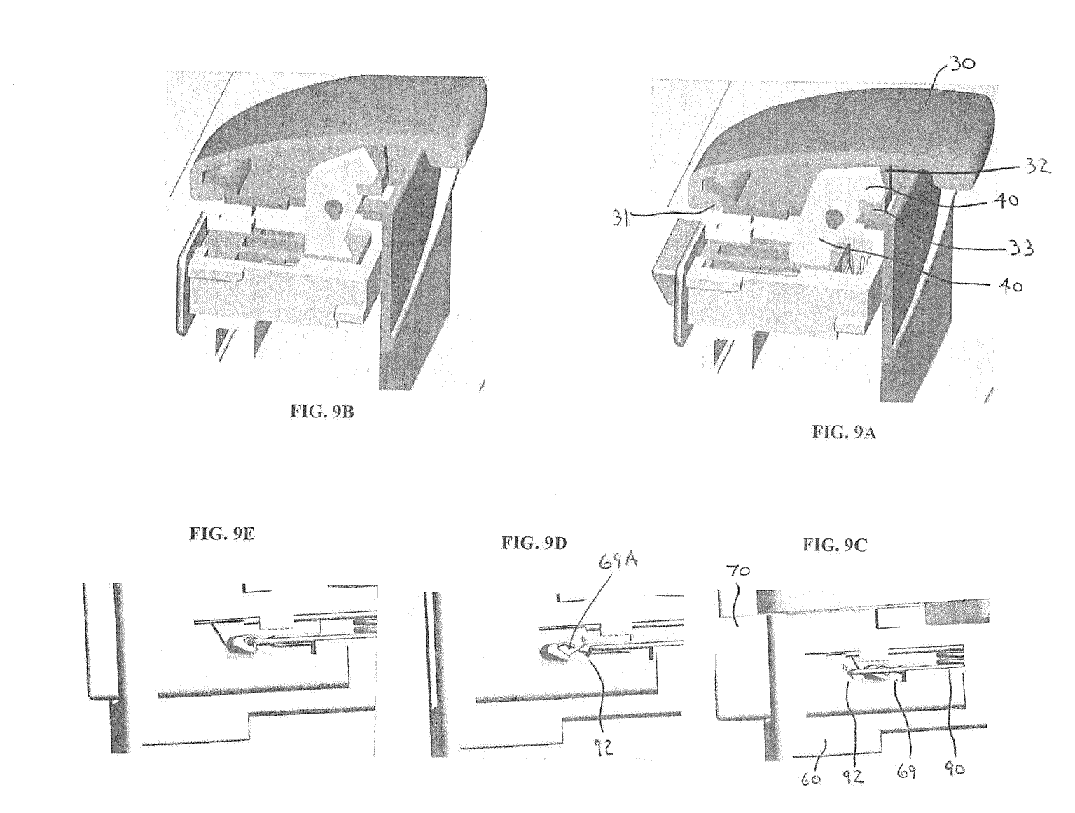

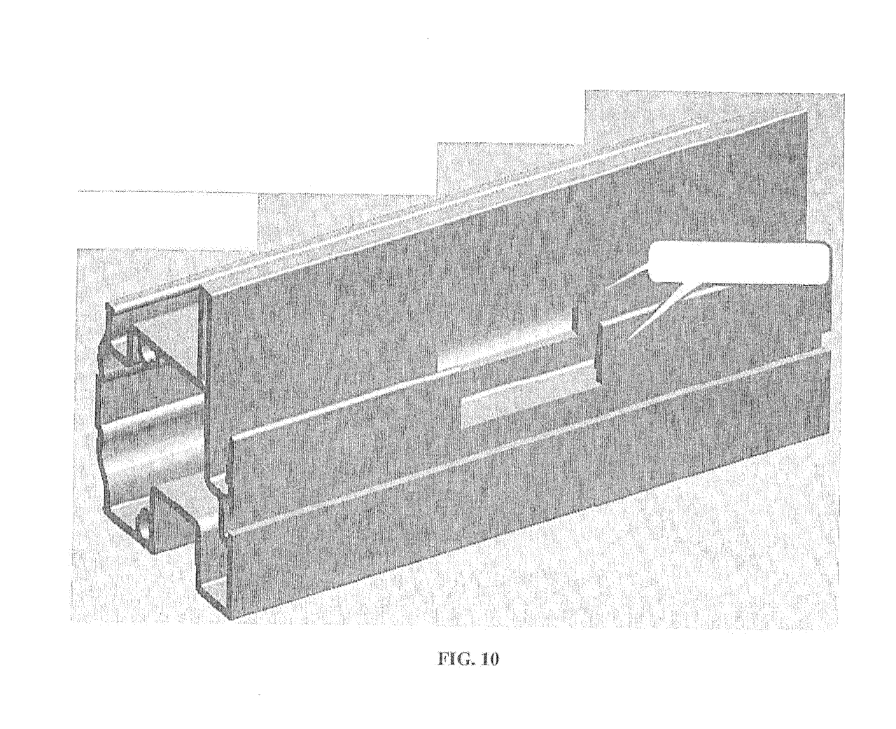

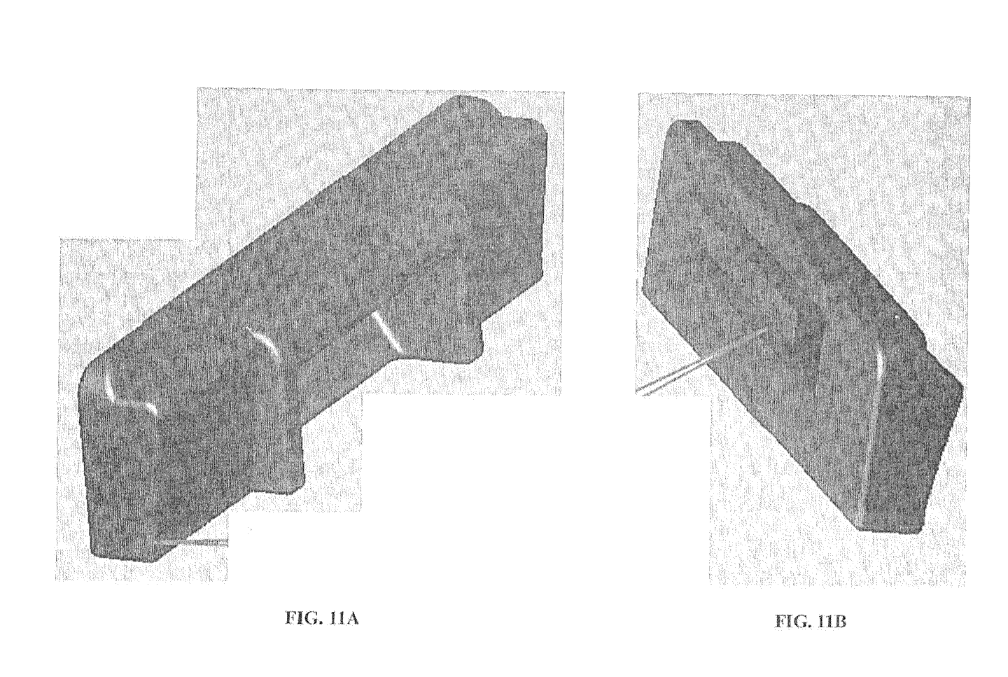

The handle 30 may be formed with a bulbous member 31 at one end (see FIG. 9A). The handle 30 may also have a protrusion 32 protruding from a central region (FIG. 4C), with a laterally protruding lip 33 formed on the end of the protrusion, to form a hook member. (Note, rather than a protruding lip, a laterally protruding cylindrical pin may be formed). The handle 30 may be assembled together with the base 20 and driving arm 40, with the bulbous member 31 being pivotably received by the hook member 21H on the upper side of the first flange 21 of base 20, and with the second end 42 of the driving arm 40 now freely resting upon the protruding lip 33 of the protrusion 32 of the handle 30 (FIG. 9A). (Note where a cylindrical pin is used instead of the lip 33, it may engage a corresponding cam surface on the arm, proximate to its second end).

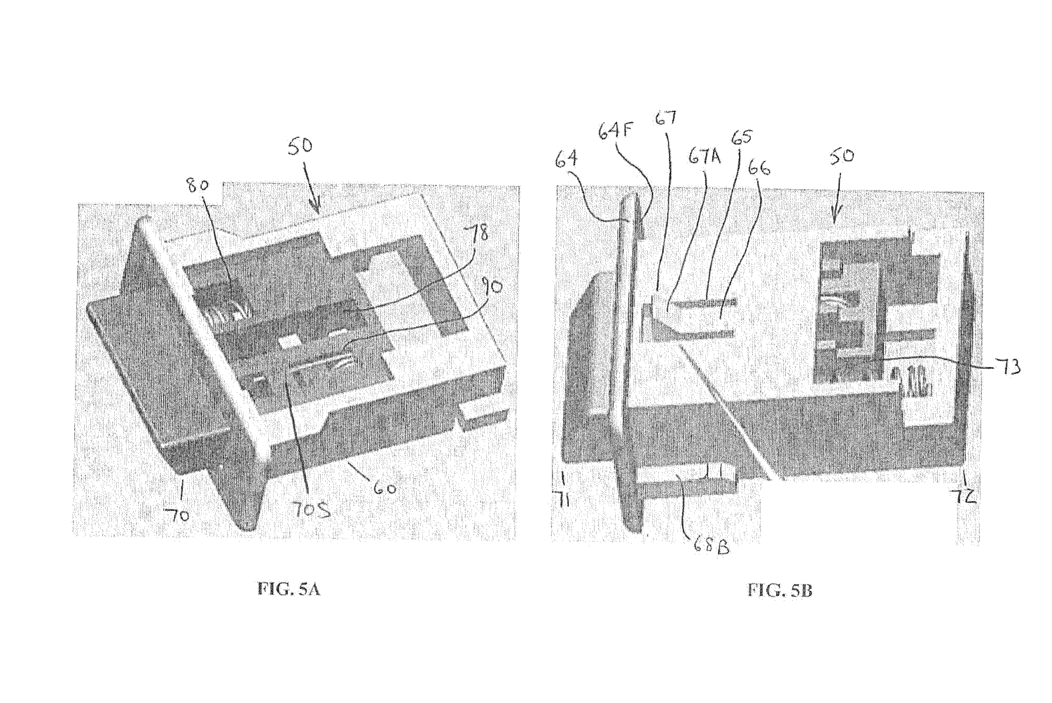

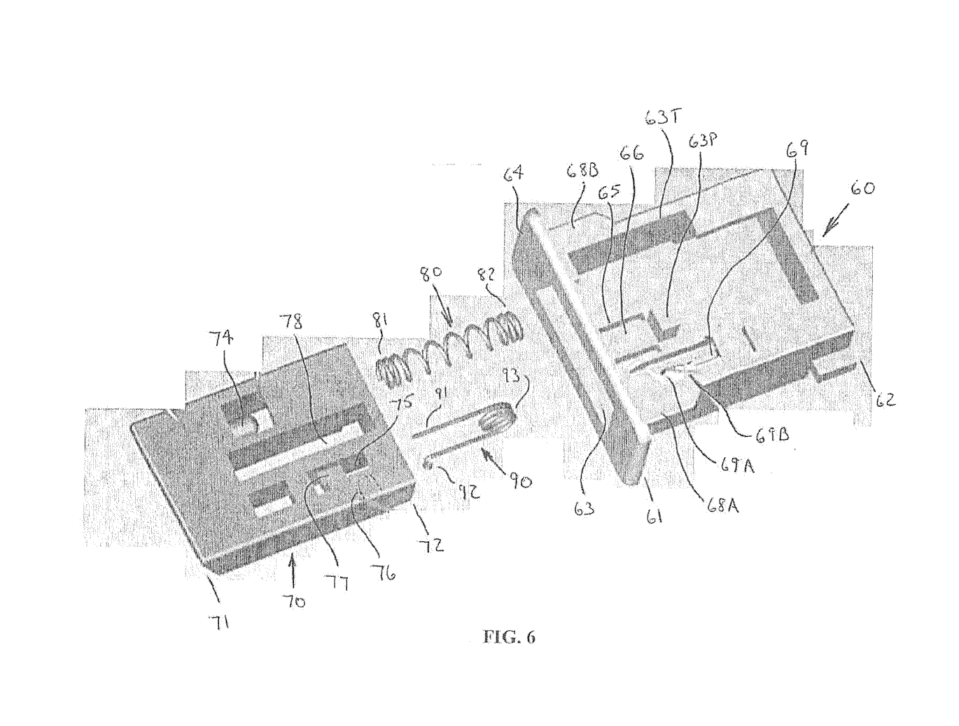

FIGS. 5A and 5B are top and bottom perspective views of the tongue assembly 50 that may be installed into a window/door frame 100, in conjunction with the lock handle assembly 10 of FIG. 4A, to form the lock of the present invention. The tongue assembly 50 may include a tongue housing 60, a tongue 70, a helical spring 80, and a torsion spring 90, as seen in the exploded view of FIG. 6.

The tongue 70 may be an elongated member, which may be generally rectangular in cross-section, having a first end 71, and a second end 72. The first end 71 of the tongue 70 may be angled and may be configured to engage a portion of the master frame 120 when the lock is in the locked position. The tongue 70 may have an opening 73 therein (see FIG. 5B) that may extend at least part way from its second end 72 towards the first end 71. Protruding into the opening 73, towards the second end 72, may be a cylindrical post 74 (FIG. 6) that may be configured to receive the first end 81 of helical spring 80 thereon, which may be used to bias the tongue out from the tongue housing 60. The tongue 70 may have an opening 75 extending between its top and bottom surfaces (i.e., transverse to opening 73 and interconnecting therewith), and into which may extend a cylindrical post 76 and a protrusion 77. The post 76 and the protrusion 77 may be used for affixing a torsion spring 90 to the tongue 70. The torsion spring 90 may have a series of turns 93 which may terminate in a first arm having a first end 91, and a second arm having a second end 92. The turns 93 of torsion spring 90 may be received upon the cylindrical post 76 of the tongue 70, and the first end 91 of a first arm of the torsion spring 90 may fixedly secure the torsion spring 90 to the tongue by being nested between the protrusion 77 and the exterior shell portion 70S of the tongue (FIG. 5A). The second end 92 of the second arm of the torsion spring 90 may be configured, with respect to the first end 91 and the turns 93, when mounted upon post 76, so as to normally protrude out of the opening 75 to extend beyond the bottom surface of the tongue to selectively contact the tongue housing 60. Note that the mounting post 76 need not be used for mounting of the turns 93 of the torsion spring 90, without which the second arm and second end 92 of the torsion spring may flex more freely, as a result of the hereinafter described engagement with the tongue housing 60. Furthermore, the complete torsion spring need not even, be utilized for the tongue assembly 50, and a flexible member may instead be mounted to the tongue 70 to extend and protrude to be similar to the second-arm and second end 92 of the spring. This flexible member may be made of a more flexible material than the torsion spring, so that its tendency to flex may be comparable, despite not have the turns to aid such flexure.

The tongue housing 60 may be an elongated member that may have a shape that generally corresponds to the shape of the tongue 70, and thus may also have a generally rectangular cross-section. The tongue housing 60 may have a first end 61 and a second end 62. The first end 61 of tongue housing 60 may have an opening 63 defining a cavity, into which the tongue 70 may be slidably received, and the top of the tongue housing may also have an opening 63T that may interconnect with the opening 63, to thereby expose the interior of the tongue housing. The cavity resulting from opening 63 may extend a sufficient distance toward the second end 62 to permit the tongue to completely retract therein.

A flange 64 that may protrude beyond the extent of the housing may extend outwardly from the tongue housing 60 at its first end 62. The flange 64 may extend from only a portion of the periphery of the opening 63, or may instead extend in each direction around the opening, and may extend generally perpendicularly away from the body of the tongue housing. A U-shaped opening 65 may be formed in the bottom side of the tongue housing 60 (FIG. 5B and FIG. 6) to create an elongated tab member 66, the end of which may have a lip 67 protruding outwardly therefrom. The end of the elongated tab member 66 and the lip 67 may be formed in proximity to the side 64F of the flange 64. A first side 67A of the lip 67 on the elongated tab member 66 may be formed at an acute angle with respect to the side of the tongue housing on which it is formed, while a second side of the lip 67 may be formed to be substantially parallel to the side 64F of the flange 64. The distance between the second side of the lip 67 and the side 64F of the flange 64 may be set to therein receive a portion of the wail of the frame 100 of the window/door, as discussed hereinafter.

A pair of flanges 68A and 68B may be formed to extend outwardly from a portion of each of the sides of the tongue housing 60, the ends of which may be angled, as seen in FIG. 5B. A protrusion 63P may be formed to protrude into the cavity formed by opening 63 of the tongue housing 60, and may be configured to engage an end of a transverse opening (e.g., opening 78) in the tongue 70, to limit its outward travel from the tongue housing to produce the completed tongue assembly 50 shown in FIG. 5A. Alternatively, the sliding travel of the tongue 70 out of the opening 63 of tongue housing 60 may be limited by the handle 30 contacting the first flange 21, with the arm 40 limiting travel of the tongue 70 through the hereinafter described engagement therebetween. Alternatively, the use of a track 69, which may be formed in the bottom of the tongue housing 60, and interaction therewith of the second end 92 of torsion spring 90, as discussed hereinafter, may serve to limit the outward travel of the tongue 70 from the tongue housing 60.

As seen in FIGS. 5A and 5B, the tongue 70 may have the torsion spring 90 (or elongated flexible member) installed therein as described hereinabove, and the tongue may also receive the first end 81 of the helical spring 80 onto the post 74, after which the tongue may be slidably inserted through the opening 63 of the tongue housing 66. The second end 82 of the helical spring 80 may be held captive by a portion of the second end 72 of the tongue housing 70, and the helical spring 80 may serve to normally bias the tongue 70 outwardly from the opening 63 of the tongue housing. For the tongue assembly 50, the sliding travel of the tongue 70 out from the opening 63 of tongue housing 60, once installed therein, may be in part determined by sliding, movement of a rounded second end 92 of the torsion spring 90 with respect to features of the track 69 into the recess 69A, as discussed further hereinafter.

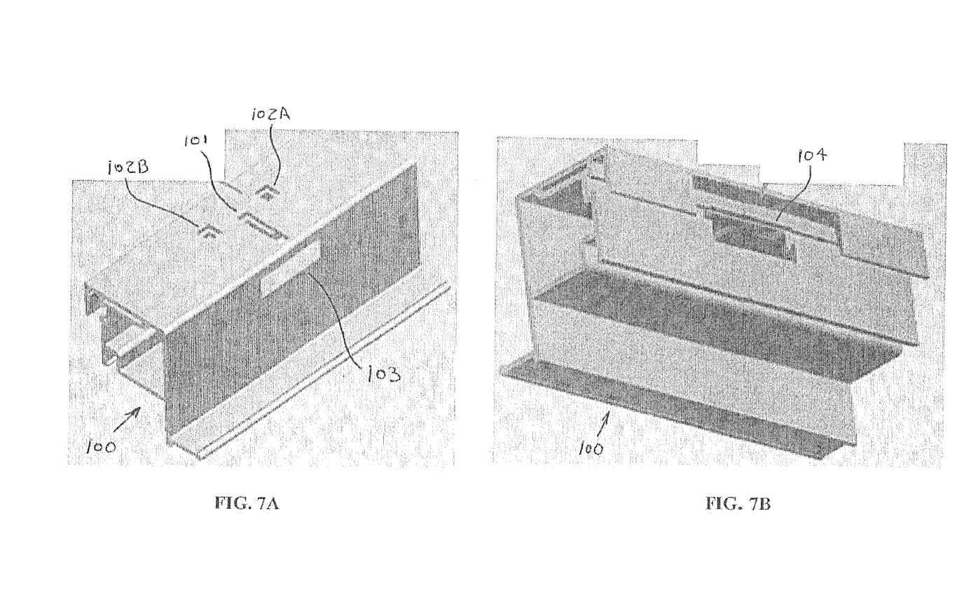

To be able to suitably mount the lock handle assembly 10 and the tongue assembly SO of the present invention with respect to the window/door frame 100, the frame may have shaped openings formed therein, as shown in FIGS. 7A and 7B. As seen in FIG. 7A, the top of the frame 100 may have an elongated opening 101 formed therein that may be configured to receive the first end 41 of driving arm 40 therethrough. Openings 102A and 102B may be configured to correspondingly receive the protrusions 21Pi and 21Pii of the first flange 21. The opening 103 on one side of the frame 100 may be configured to receive the hook-shaped members 22Hi and 22Hii of the second flange 22 of base member 20 of lock handle assembly 10. As seen in FIG. 7B, the opening 104 on a second side of the frame 100 may be configured to receive a portion of the tongue assembly 50 therethrough.

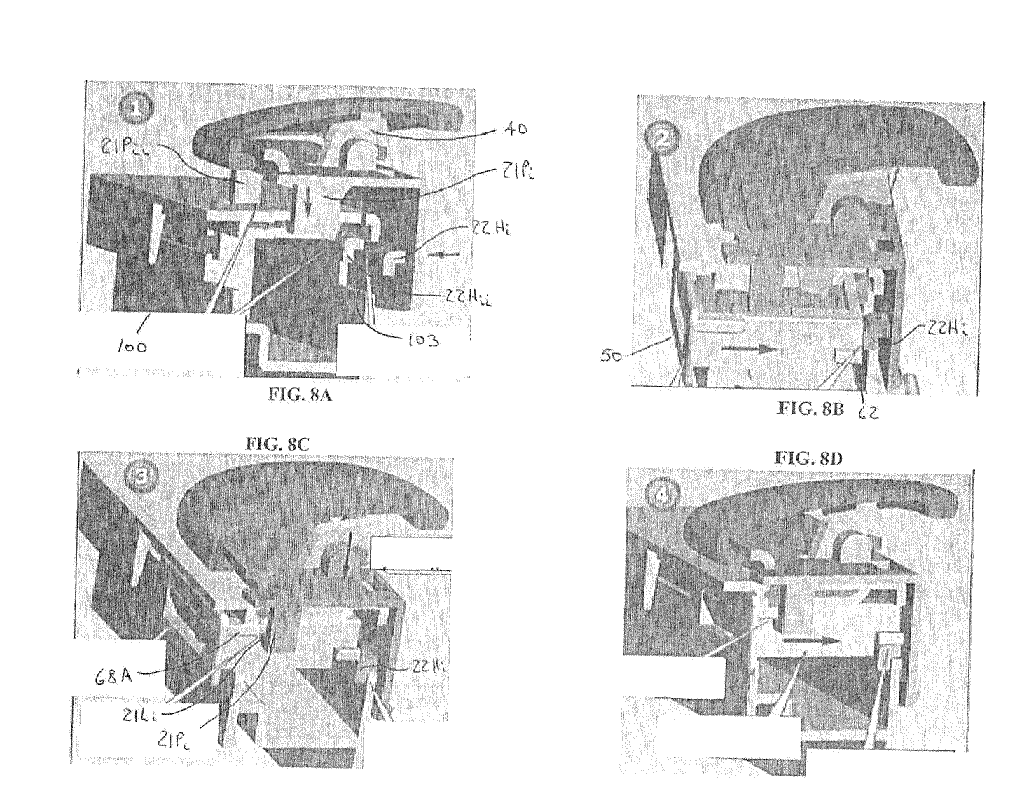

The sequenced installation of the lock handle assembly 10 and the tongue assembly 50 through those openings in the frame 100 may be seen within FIGS. 8A through 8D. Initially, as shown in FIG. 8A, the lock handle assembly 10 may be installed upon the frame 100. The first end 41 of the driving arm 40 may be received through the opening 101, the hook members of the first flange 21 (i.e., first protrusion 21Pi with protruding lip 21Li, and second protrusion 21Pii with lip 21Lii) may be respectively inserted through openings 102A and 102B, and the hook-shaped members 22Hi and 22Hii of the second flange 22 of base member 20 may be inserted through opening 103.

Next, as seen in FIG. 8B, the tongue assembly 50 may be inserted part-way into opening 104 of frame 100. The lock handle assembly 10 may then be pushed further downward to be in contact with the top of the frame 100, and so that the first end 41 of the driving arm 40 is received through the opening 78 in the top of the tongue 70, and so that the hook-shaped members 22Hi and 22Hii are hooked around the opening 103, as seen in FIG. 5C. Receiving the first end 41 of the driving arm 40 within the opening 78 in the top of the tongue 70 may permit actuation of the handle 30 to be transmitted to the tongue, through the driving arm 40, and that connection may also normally bias the handle 30 downward towards the frame 100 (i.e., towards the locked position) as a result of the-outward biasing of the tongue by helical spring 80.

The tongue assembly 50 may be pushed further into opening 104, so that the angled portion of the flanges 68A and 68B on each of the sides of the tongue housing 60 respectively engage (and/or outwardly deflect.) the hook members of the first flange 21 (i.e., first protrusion 21Pi with protruding lip 2iLi, and second protrusion 21Pii with lip 21Lsi), as seen in FIG. 8C. Continued insertion of the tongue assembly 50 into opening 104 may also result in respective engagement between the flanges 68A and 68B of the tongue housing 60, the hook members of the first flange 21, as seen in FIG. 8D. As the tongue assembly 50 continues to be inserted, the angled side 67A of protrusion 67 may contact the edge of the opening 104 in frame 100, and through such contact of the angled surface with the frame opening, the elongated tab member 66 may be deflected into the tongue housing 60. Continued insertion of the tongue assembly 50 into opening 104 may finally result in the side 64F of the flange 64 of the tongue housing 60 contacting the exterior of the frame 100. As such contact is made, the elongated tab member 66 may move clear of the frame wall and return to its un-deflected position, and the lip 67 on the elongated tab member 66 may become disposed on the inside of the wall that forms the opening 104 in frame 100. The tongue assembly 50 may thus be retained in this installed position by a portion of the wall of the frame 100 at opening 104 being trapped between the side 64F of the flange 64 of the tongue housing 60, and the angled side 67A of protrusion 67 of the elongated tab member 66.

Operation of the installed lock of the present invention may be understood through the cut-away illustrations in FIGS. 9A through 9E. In FIG. 9A the installation is shown with the handle 36 of the lock assembly 10 being biased into its lowered position, and the tongue 70 is correspondingly in its extended (locked) position. Outward movement of the tongue 70 may be limited to this extended position by the protrusion 63P formed in the opening 63 of the tongue housing 60 engaging with the end of a transverse opening (e.g., opening 78), or by the handle 30 contacting the first flange 21, as described above. When the tongue is in the extended (locked) position, the rounded second end 92 of the torsion spring 90 may be positioned distally from the track 69 of the tongue housing 60, as seen in FIG. 9C.

When the user lifts the handle 30 of the lock arrangement shown in FIG. 9A to move the tongue 70 into the unlocked position, the second end 42 of the driving arm 40 may be actuated by the protruding lip 33 of the protrusion 32 of the handle 30, and the first end 41 of the driving arm 40 may pivot about the pin portions 43A and 43B, and drive the tongue 70 to oppose its biasing by helical spring 80, and cause it to retract completely into the tongue housing 60. This translational movement of the tongue 70 into the tongue housing 60 may cause the rounded second end 92 of the torsion spring 90 to move toward the track 69 of the tongue housing 60, where it may encounter a first contour that may surround the recess 69A, and contact with the contour may cause the second end 92 of spring 90 to be deflected laterally in a first direction, until it is past that first contour, and reaches the position shown in FIG. 9D. When the user releases the handle 30, the outward biasing of the tongue 70 by helical spring 80 may cause the rounded second end 92 of the torsion spring 90 to briefly move along a second contoured portion of the track 69 of the tongue housing 60, until it is releasably received within the recess 69A of the track, as seen in FIG. 9E. The tongue 70 may thus be retained in the retracted position shown in FIG. 9B.

When the user again lifts the handle 30 of the lock, the second end 42 of the driving arm 40 is again actuated by the protruding lip 33 of the handle protrusion 32, and the first end 41 of the driving arm 40 may again drive the tongue 70 to oppose its biasing by helical spring 80 and may cause it to retract a small amount into the tongue housing 60. This translational movement of the tongue 70 into the tongue housing 60 may also cause the rounded second end 92 of the torsion spring 90 to egress from the recess 69 A and move along another contoured portion of the track 69 of the tongue housing 60. When the user releases the handle 30, the outward biasing of the tongue 70 by helical spring 80 may then cause the rounded second end 92 of the torsion spring 90 to move along vet another contoured portion of the track 69 of the tongue housing 60 so as to be deflected in a second direction to now avoid capture within recess 69A of the track. This permits unrestrained outward biasing of the tongue 70, and return of the rounded second end 92 of the torsion spring 90 back to the position shown in FIG. 9C.

This interaction of spring 90 and track 69 may operate similar to the spring and track disclosed in the Applicant's co-pending application Ser. No. 14/090,124, the disclosures of which are incorporated herein by reference.

It should be noted that for the arrangement shown herein, with the lever provided by driving arm 40, the handle may only require five degree of lift (a relatively short “throw”) to open (unlock) the device.

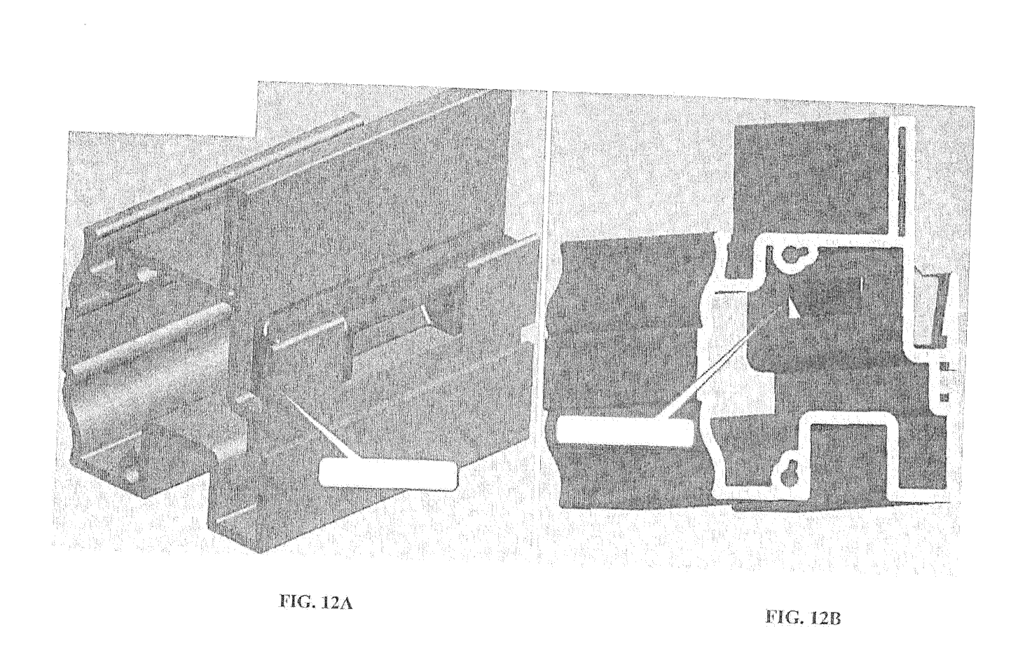

As an alternative to simply utilizing an opening in the master frame 120, a keeper 121 may instead be retained therein, and which may receive the protruding portion of the tongue 70 in the locked position, as seen in FIGS. 12A and 12B.

The examples and descriptions pro vided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

What is claimed is:

1. A screwless-mounted lock, for use on sliding doors and on sliding windows, said lock comprising:
a base member, said base member comprising:
a first flange having a first end and a second end, and having a first side and a second side, said first flange comprising: a through-opening; a first hook member, and a second hook member facing said first hook member, and with each said hook member protruding from said first side; and
a second flange extending away from said first flange, said second flange comprising at least one hook member;
a handle member pivotally coupled to said first flange, to be pivotable between at least a first position and a second position; said handle member comprising a protrusion;
an arm having a first end and a second end; said arm received through said opening in said first flange and pivotally mounted thereto, for said first end and a first portion of said arm to protrude from said opening to be a first distance away from said pivotal mounting with said first flange, and for said second end and a second portion of said arm to protrude from said opening a second distance away from said pivotal mounting with said first flange;
wherein a portion of said handle protrusion is configured to selectively engage and drive said second end of said arm, and correspondingly move said first end of said arm from a first arm position to a second arm position, when said handle is pivoted from said first handle position to said second handle position;
a tongue assembly comprising:
a housing having a first opening into a cavity therein, and a transverse opening into said cavity; said housing comprising:
a face plate;
a flexible tab with a protruding lip at a lateral distance from said face plate;
a first side protrusion and a second side protrusion configured to be respectively engaged by said first and second hook members of said first flange, to secure said tongue assembly with respect to said base member;
a tongue configured to be slidably received through said first housing opening, to be slidable between an extended position, and a stowed position where said tongue is retracted within said cavity; said tongue comprising an opening with at least a portion thereof aligned with said transverse housing opening; and
wherein said first end of said arm is configured to protrude through said transverse housing opening to be movably engaged within said tongue opening;
wherein said movement of said first end of said arm between said first and second arm positions selectively causes corresponding movement of said tongue between said retracted and extended positions.

2. The lock of claim 1 wherein said first distance is greater than said second distance.

3. The lock of claim 1 wherein said portion of said handle protrusion being configured to selectively engage and drive said first end of said arm comprises:
said portion of said handle member protrusion being formed into a pin; and
a cam surface formed proximate to said second end of said arm, said pin configured to engage said cam surface to drive said arm.

4. The lock of claim 1 wherein said portion of said handle protrusion being configured to selectively engage and drive said first end of said arm comprises:
said portion of said handle member protrusion being formed into a laterally protruding flange; and said laterally protruding flange configured to contact and drive said second end of arm, said second end of said arm comprising a rounded surface.

5. The lock of claim 1 further comprising:
biasing means positioned within said cavity of said tongue housing, said biasing means configured to bias said tongue outward from said cavity;
a shaped track on said tongue housing within said cavity;
a flexible member having a first end secured to said tongue, said flexible member having a second end configured to selectively engage said shaped track on said tongue housing;
wherein when said handle is actuated to overcome said biasing of said biasing means to pivot from said first handle position to said second handle position and is subsequently released, said selective engagement comprises:
said second end of said flexible member initially moving in a first direction and subsequently being deflected in a first lateral direction from contact with a first contour of said track until said handle is released; and biasing by said biasing means, after said handle is released, to cause said second end of said flexible member move in a second direction to engage a recess in said tongue housing track to retain said handle at an intermediate position between said first handle position and said second handle position; said tongue being in said retracted position with said handle at said intermediate handle position; and
wherein when said handle is actuated to overcome said biasing of said biasing means to pivot from said intermediate handle position to said second handle position and is subsequently released, said selective engagement comprises:
said second end of said flexible member moving in said first direction to disengage from said recess and be deflected in a second lateral direction from contact with a second contour of said track, until said handle is released; and said second end of said flexible member being biased to move in said second direction for said handle to be biased back into said first handle position, and said tongue to be biased into said extended position.

6. A screwless-mounted lock comprising:
a handle assembly, said handle assembly comprising;
a base member comprising: a plurality of selectively arranged hook members, a first portion of said selectively arranged hook members being received through an opening in a first side wall of the window/door frame to secure said handle assembly thereto in a horizontal direction;
a handle member pivotally mounted to said base member to be pivotable between a first handle position and at least a second handle position; and
an elongated arm with a portion thereof disposed through an opening in said base member, said arm pivotally mounted to said base member; wherein pivotal movement of said handle between said first and second handle positions is configured to drive said arm to pivot;
a tongue assembly, said tongue assembly comprising;
a tongue housing comprising: a pair of protrusions; a face plate; and a flexible tab with a protruding hp positioned at a lateral distance from said face plate; said tongue housing configured to be received through an opening in a second side wall of the window/door frame, with said face plate and said lip of said flexible table configured to engage the second side wall to secure said tongue housing thereto; and
a tongue, said tongue being slidably received in said tongue housing, and configured to translate between an extended locking position and at least one retracted position, according to said pivotal movement of said elongated arm, being driven by said handle movement between said first and second handle positions; and
wherein a pair of said plurality of selectively -arranged hook members are received through corresponding openings in a top wall of the window/door frame to engage said pair of protrusions on said tongue housing, to secure said handle assembly thereto in a vertical direction.

7. The lock of claim 6 further comprising:
biasing means configured to bias said tongue into said extended position;
a shaped track within said tongue housing;
a flexible member having a first end secured to said tongue, said flexible member having a second end configured to selectively engage said shaped track;
wherein when said handle is actuated to overcome said biasing of said biasing means to pivot from said first handle position to said second handle position and is subsequently released, said selective engagement comprises:
said second end of said flexible member initially moving in a first direction and subsequently being deflected in a first lateral direction from contact with a first contour of said track, until said handle is released; and biasing by said biasing means, after said handle is released, to cause said second end of said flexible member move in a second direction to engage a recess in said tongue housing track to retain said handle at an intermediate handle position being between said first handle position and said second handle position; said tongue being in said retracted position with said handle at said intermediate handle position; and
wherein when said handle is actuated to overcome said biasing of said biasing means to pivot from said intermediate handle position to said second handle position and is subsequently released, said selective engagement comprises:
said second end of said flexible member moving in said first direction to disengage from said recess and be deflected in a second lateral direction from contact with a second contour of said track, until said handle is released; biasing by said biasing means, after said handle is released, to cause said second end of said flexible member to move in said second direction, for said handle to be biased back into said first handle position, and said tongue to be biased into said extended locking position.
